(19) United States
(12) Patent Application Publication
(10) Pub. No.: US 2022/0335184 A1
(43) Pub. Date: Oct. 20, 2022

(54) WELL CONSTRUCTION ACTIVITY GRAPH BUILDER

(71) Applicant: LANDMARK GRAPHICS CORPORATION, Houston, TX (US)

(72) Inventors: Avinash WESLEY, New Caney, TX (US); Amir BAR, Houston, TX (US); David CRAWSHAY, Spring, TX (US)

(73) Assignee: LANDMARK GRAPHICS CORPORATION, Houston, TX (US)

(21) Appl. No.: 17/631,590

(22) PCT Filed: Sep. 4, 2019
(86) PCT No.: PCT/US2019/049437

§ 371 Date: Jan. 31, 2022

(51) Int. Cl. G06F 30/28

(52) U.S. Cl. CPC G06F 30/28

(57) ABSTRACT

Systems, methods, and computer-readable media for a well construction activity graph builder. An example method can include obtaining a stream of events associated with a wellbore; obtaining mapping metadata identifying data points to be included in a graph data model from a store of data associated with the wellbore; generating the graph data model based on the stream of events, the mapping metadata, and the data points identified in the mapping metadata, the graph data model including nodes representing logical entities associated with the data points, the nodes having interconnections based on data relationships defined in the mapping metadata, each logical entity corresponding to a set of data points from the data points; and generating a view of the graph data model, the view depicting at least some of the nodes and interconnections in the graph data model.

### TECHNICAL FIELD

The present technology pertains to building wells and, more specifically, building graphs of well construction activities.

### BACKGROUND

In the oil and gas industry, the design and construction of a well can be extremely important to the safe and effective exploration and extraction of oil and gas resources. However, modern well design and construction has become increasingly complex, often involving a vast amount of users, operations, tools, and data points. For example, the design and construction of a well can involve thousands of different data points pertaining to various aspects of the well design and construction lifecycle, such as user activity, well conditions, well operations, well design and construction tools, and so forth. This increasing complexity and nearly intractable volume of data can create significant challenges in modern well design, construction and completion, as well operators struggle to track and understand the different data points involved throughout the well design and construction lifecycle.

These problems are greatly exacerbated by the lack of tools available for adequately tracking and maintaining a comprehensive timeline and record of well design and construction data points, and intelligently storing, organizing, and presenting such information for well operators. Moreover, the limited availability and the difficulty of access of such information can create difficult obstacles for well operators as they try to evaluate different well conditions and activity in order to implement a successful well plan and adapt to changing circumstances in the well design and construction lifecycle. These and other limitations can have a negative impact on the safety, design and construction of modern wells.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1A is a schematic diagram of an example logging while drilling (LWD) wellbore operating environment, in accordance with some examples;

FIG. 1B is a schematic diagram of an example downhole environment having tubulars, in accordance with some examples;

FIG. 2 is a diagram of an example data management system for generating a graph data model for storing and managing well design and construction activity and data, in accordance with some examples;

FIG. 3 is a diagram of an example system flow for generating a graph data model for well design and construction data, in accordance with some examples;

FIG. 4 is a diagram of an example graph data model of well design and construction data, in accordance with some examples;

FIG. 5 is an example view of well design and construction activity and data generated based on a graph data model of well design and construction data, in accordance with some examples;

FIG. 6 is a flowchart of an example method for generating a graph data model of well design and construction activity and data, in accordance with some examples; and

FIG. 7 is a schematic diagram of an example computing device architecture, in accordance with some examples.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Disclosed are systems, methods, and computer-readable storage media for generating a graph data model of well design and construction data. The graph data model can capture, store, organize, and present well-related data including, for example, well design and construction activity (e.g., operations, events, etc.), well attributes and conditions, user-generated data (e.g., reports, notes, configurations, analytics, edits, attributes, etc.), system or application data (e.g., data entered into one or more systems or applications, data retrieved and/or modified from one or more systems or applications, etc.), user activity (e.g., user actions, data entry, data interactions, user-generated changes, etc.), timestamps associated with specific events (e.g., user activity, well activity, attributes, data interactions, changes, etc.), historical data, and so forth.

For example, the graph data model can capture, store, organize, and present data entered by users (past and present) into one or more storage systems (e.g., databases, servers, applications, etc.), a timeline and/or record of changes or edits performed by one or more users, a record of attributes (past and present), a record of deleted data (e.g., attributes, user inputs, event data, etc.), a type and level of user data interactions (e.g., data entry, data edits, data removal, data open or view counts, data interaction timestamps, etc.), a record of tools or applications used to generate data and make changes, a record of when data was entered into a system or application, a record of when changes were made by one or more users, and/or any other pertinent data for the well design and construction lifecycle.

The data captured by the graph data model can be comprehensive and can persist even after being marked for deletion. Moreover, such data can help well operators evaluate different well conditions and activity in order to implement a successful well plan and adapt to changing circumstances. The data captured by the graph data model can be intelligently organized for space efficiency and ease of access, even if some or all of the data originates from, or is distributed across, different systems, applications, and/or databases. The graph data model can correlate and/or cluster similar or related data and keep such data in close proximity to enable space or storage savings, fast searching, robust access and queries, flexible and intelligent visualizations, and logical modeling. The graph data model can capture large volumes of data and visually present relevant and/or related data in a user-friendly and configurable manner. The data can be visually presented in a variety of formats and configurations, such as three-dimensional structures, spreadsheets, charts, etc.

According to at least one example, a method for generating a graph data model of well design and construction data is provided. The method can include obtaining a stream of events associated with a wellbore; obtaining mapping metadata identifying data points to be included in a graph data model from a store of data associated with the wellbore; generating the graph data model based on the stream of events, the mapping metadata, and the data points identified in the mapping metadata, the graph data model including nodes representing logical entities associated with the data points, the nodes having interconnections based on data relationships defined in the mapping metadata, wherein each logical entity corresponds to a set of data points from the data points; and generating a view of the graph data model depicting at least some of the nodes and interconnections in the graph data model.

In another example, a system for generating a graph data model of well design and construction data is provided. The system can include one or more processors and at least one computer-readable storage medium having stored therein instructions which, when executed by the one or more processors, cause the system to obtain a stream of events associated with a wellbore; obtain mapping metadata identifying data points to be included in a graph data model from a store of data associated with the wellbore; generate the graph data model based on the stream of events, the mapping metadata, and the data points identified in the mapping metadata, the graph data model including nodes representing logical entities associated with the data points, the nodes having interconnections based on data relationships defined in the mapping metadata, wherein each logical entity corresponds to a set of data points from the data points; and generate a view of the graph data model depicting at least some of the nodes and interconnections in the graph data model.

In another example, a non-transitory computer-readable storage medium for generating a graph data model of well design and construction data is provided. The non-transitory computer-readable storage medium can include instructions which, when executed by one or more processors, cause the one or more processors to obtain a stream of events associated with a wellbore; obtain mapping metadata identifying data points to be included in a graph data model from a store of data associated with the wellbore; generate the graph data model based on the stream of events, the mapping metadata, and the data points identified in the mapping metadata, the graph data model including nodes representing logical entities associated with the data points, the nodes having interconnections based on data relationships defined in the mapping metadata, wherein each logical entity corresponds to a set of data points from the data points; and generate a view of the graph data model depicting at least some of the nodes and interconnections in the graph data model.

In yet another example, a system or apparatus for generating a graph data model of well design and construction data is provided. The system or apparatus can include means for obtaining a stream of events associated with a wellbore; obtaining mapping metadata identifying data points to be included in a graph data model from a store of data associated with the wellbore; generating the graph data model based on the stream of events, the mapping metadata, and the data points identified in the mapping metadata, the graph data model including nodes representing logical entities associated with the data points, the nodes having interconnections based on data relationships defined in the mapping metadata, wherein each logical entity corresponds to a set of data points from the data points; and generating a view of the graph data model depicting at least some of the nodes and interconnections in the graph data model.

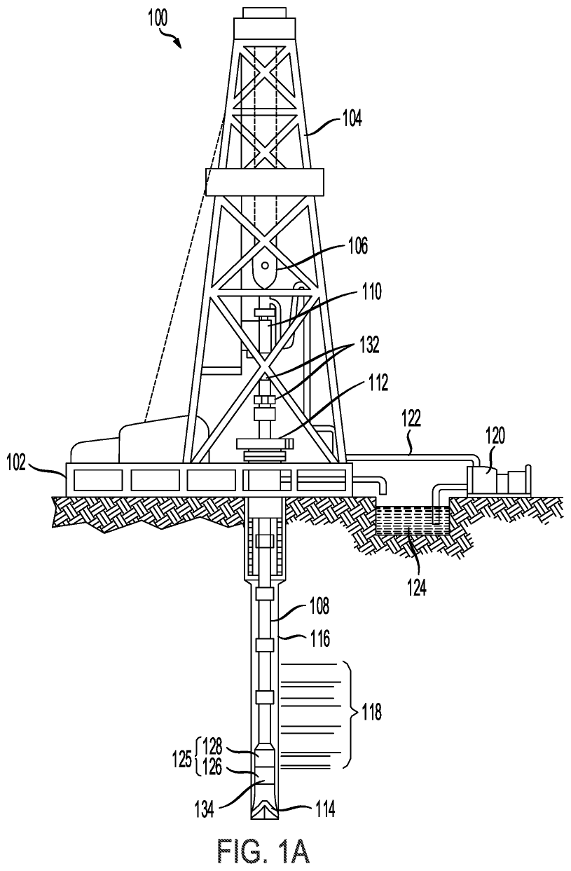

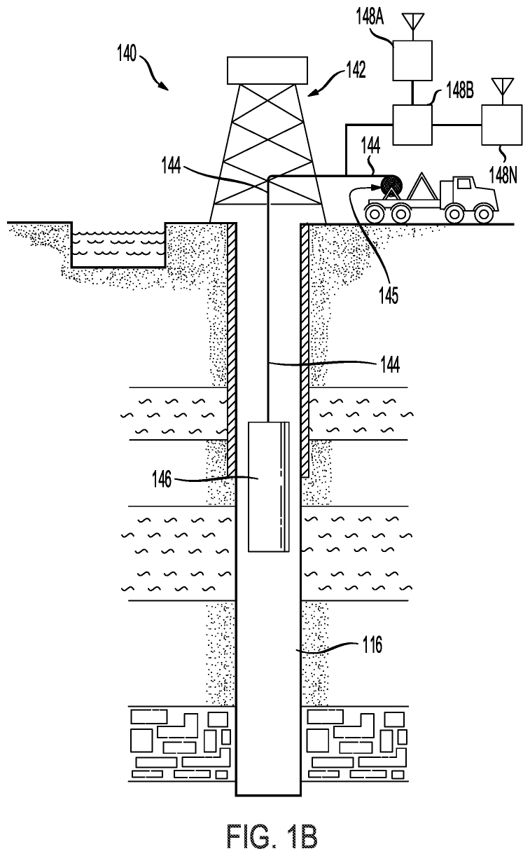

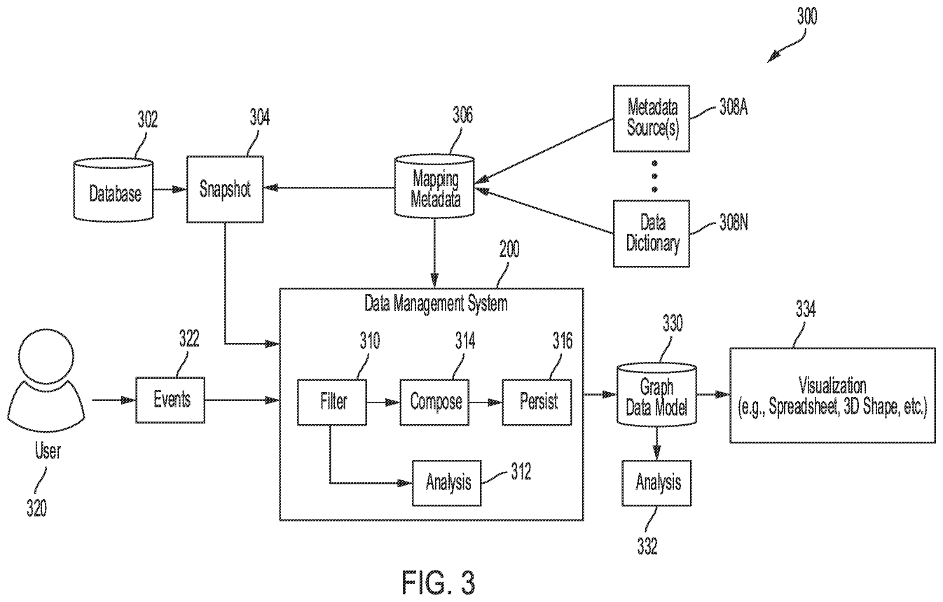

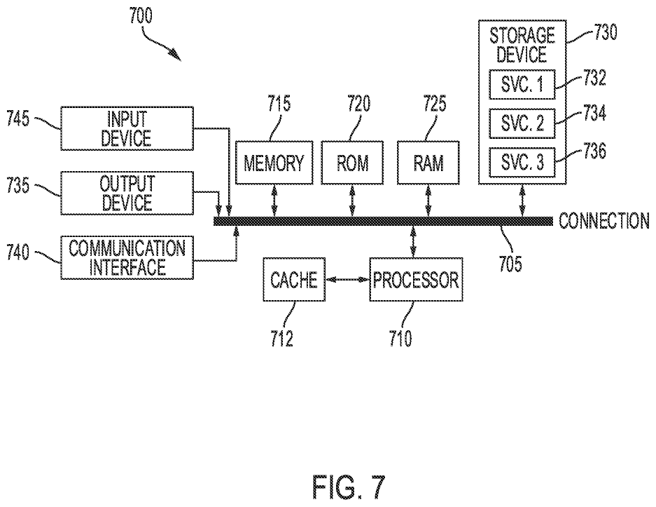

As follows, the disclosure will begin with a description of example systems and environments for generating a graph data model of well design and construction data and activity, as illustrated in FIGS. 1A-C and 2. A detailed description of example systems, methods, and technologies for generating a graph data model of well design and construction data and activity, as shown in FIGS. 3-6, will then follow. The disclosure concludes with a description of an example computing system architecture, as shown in FIG. 7, which can be implemented for performing computing operations and functions as disclosed herein. These variations shall be described herein as the various embodiments are set forth. The disclosure now turns to FIG. 1A.

FIG. 1A illustrates a schematic view of a logging while drilling (LWD) wellbore operating environment 100 in in accordance with some examples of the present disclosure. As depicted in FIG. 1A, a drilling platform 102 can be equipped with a derrick 104 that supports a hoist 106 for raising and lowering a drill string 108. The hoist 106 suspends a top drive 110 suitable for rotating and lowering the drill string 108 through a well head 112. A drill bit 114 can be connected to the lower end of the drill string 108. As the drill bit 114 rotates, the drill bit 114 creates a wellbore 116 that passes through various formations 118. A pump 120 circulates drilling fluid through a supply pipe 122 to top drive 110, down through the interior of drill string 108 and orifices in drill bit 114, back to the surface via the annulus around drill string 108, and into a retention pit 124. The drilling fluid transports cuttings from the wellbore 116 into the retention pit 124 and aids in maintaining the integrity of the wellbore 116. Various materials can be used for drilling fluid, including oil-based fluids and water-based fluids.

Logging tools 126 can be integrated into the bottom-hole assembly 130 near the drill bit 114. As the drill bit 114 extends the wellbore 116 through the formations 118, logging tools 126 collect measurements relating to various formation properties as well as the orientation of the tool and various other drilling conditions. The bottom-hole assembly 130 may also include a telemetry sub 128 to transfer measurement data to a surface receiver 132 and to receive commands from the surface. In at least some cases, the telemetry sub 128 communicates with a surface receiver 132 using mud pulse telemetry. In some instances, the telemetry sub 128 does not communicate with the surface, but rather stores logging data for later retrieval at the surface when the logging assembly is recovered.

Each of the logging tools 126 may include one or more tool components spaced apart from each other and communicatively coupled with one or more wires and/or other media. The logging tools 126 may also include one or more computing devices 134 communicatively coupled with one or more of the one or more tool components by one or more wires and/or other media. The one or more computing devices 134 may be configured to control or monitor a performance of the tool, process logging data, and/or carry out one or more aspects of the methods and processes of the present disclosure.

In at least some instances, one or more of the logging tools 126 may communicate with a surface receiver 132 by a wire, such as wired drillpipe. In other cases, the one or more of the logging tools 126 may communicate with a surface receiver 132 by wireless signal transmission. In at least some cases, one or more of the logging tools 126 may receive electrical power from a wire that extends to the surface, including wires extending through a wired drillpipe.

Referring to FIG. 1B, an example system 140 for downhole line detection in a downhole environment having tubulars can employ a tool having a tool body 146 in order to carry out logging and/or other operations. For example, instead of using the drill string 108 of FIG. 1A to lower tool body 146, which may contain sensors or other instrumentation for detecting and logging nearby characteristics and conditions of the wellbore 116 and surrounding formation, a wireline conveyance 144 can be used. The tool body 146 can include a resistivity logging tool. The tool body 146 can be lowered into the wellbore 116 by wireline conveyance 144. The wireline conveyance 144 can be anchored in the drill rig 145 or a portable means such as a truck. The wireline conveyance 144 can include one or more wires, slicklines, cables, and/or the like, as well as tubular conveyances such as coiled tubing, joint tubing, or other tubulars.

The illustrated wireline conveyance 144 provides support for the tool, as well as enabling communication between tool processors 148A-N on the surface and providing a power supply. In some examples, the wireline conveyance 144 can include electrical and/or fiber optic cabling for carrying out communications. The wireline conveyance 144 can be sufficiently strong and flexible to tether the tool body 146 through the wellbore 116, while also permitting communication through the wireline conveyance 144 to one or more processors 148A-N, which can include local and/or remote processors. Moreover, power can be supplied via the wireline conveyance 144 to meet power requirements of the tool. For slickline or coiled tubing configurations, power can be supplied downhole with a battery or via a downhole generator.

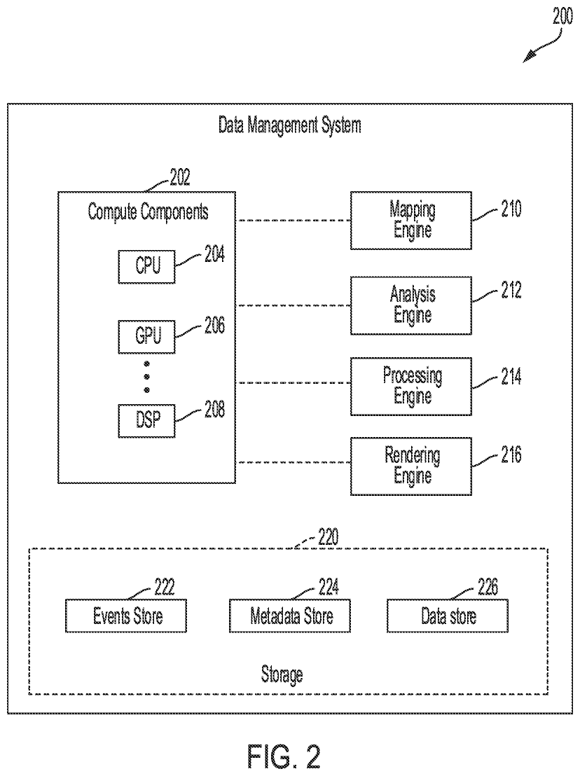

Having disclosed example drilling environments and tools, the disclosure now turns to FIG. 2, which illustrates an example data management system 200. The data management system 200 can be implemented to generate graph data models for well design and construction data (e.g., attributes, events, etc.); generate views of well design and construction data in the graph data model; search or query well design and construction data in the graph data model; organize data distributed across systems in an intelligent, efficient, and/or logical manner; etc.

In some cases, the data management system 200 can monitor and capture data and events associated with a well, such as well design and construction attributes (e.g., location, depth, cost, formations, safety factors, well components, well conditions, etc.), well operations (e.g., planning operations; design operations; construction operations; well operations details such as when an operation was performed, what tools were used for an operation, which user(s) conducted an operation, etc.), user activity (e.g., operations performed or initiated by a user, tools implemented by a user for an operation, changes made by a user to an attribute or data, data entered or modified by a user, timing information associated with a user event or activity, user event or activity details, etc.), and so forth.

The data management system 200 can be part of, or implemented by, one or more computing devices, such as one or more servers, one or more personal computers, one or more processors, one or more mobile devices (e.g., a smartphone, a camera, a laptop computer, a tablet computer, a smart device, etc.), and/or any other suitable electronic device. In some cases, the one or more computing devices that include or implement the data management system 200 can include one or more hardware components such as, for example, one or more wireless transceivers, one or more input devices, one or more output devices (e.g., a display device, an audio speaker, etc.), one or more sensors (e.g., an image sensor, a temperature sensor, a pressure sensor, an altitude sensor, a proximity sensor, an inertial measurement unit, etc.), one or more storage devices (e.g., storage 220), one or more processing devices (e.g., compute components 202), etc.

The data management system 200 can include one or more compute components 202. The compute components 202 can be used to implement the metadata mapping engine 210, the analysis engine 212, the processing engine 214, and the rendering engine 216. The compute components 202 can also be used to control, communicate with, and/or interact with the storage 220, the events store 222, the metadata store 224, the data store 226, and/or any other component of the data management system 200. The compute components 202 can include electronic circuits and/or other electronic hardware, such as, for example and without limitation, one or more programmable electronic circuits. For example, the compute components 202 can include one or more central processing units (CPUs) 204, one or more graphics processing units (GPUs) 206, and one or more digital signal processors (DSPs) 208.

In some cases, the compute components 202 can include any other or additional electronic circuits and/or hardware, such as one or more microprocessors, one or more image signal processors (ISPs), one or more controllers, and/or any other suitable electronic circuits and/or hardware. Moreover, the compute components 202 can include and/or can be implemented using computer software, firmware, or any combination thereof, to perform the various operations described herein.

The data management system 200 can include a storage 220 for storing data. The storage 220 can include one or more storage device(s) capable of storing data, hosting databases, etc. The storage 220 can store data from any of the components of the data management system 200. For example, the storage 220 can store input data used by the data management system 200, outputs or results generated by the data management system 200 (e.g., data and/or calculations from the metadata mapping engine 210, the analysis engine 212, the processing engine 214, the rendering engine 216, etc.), user preferences, databases, data models, graphs, metadata, events or activity information, well construction or design attributes, system parameters and configurations, data logs, documents, software, media items, GUI content, and/or any other data and content. The storage 220 can be implemented by a single storage device or multiple storage devices.

In some implementations, the storage 220 can include a buffer or cache for storing data for processing by the compute components 202. Moreover, in some implementations, the storage 220 can include an events store 222, a metadata store 224 and a data store 226. The events store 222, metadata store 224 and data store 226 can each include or implement one or more storage systems, such as one or more storage devices, one or more storage volumes, one or more storage servers, one or more databases, etc. The events store 222 can store events (e.g., activity, actions, etc.) captured or collected by the data management system 200, such as user events, well design or construction events, etc.

The metadata store 224 can store metadata such as timestamps, labels, tags, flags, attributes, data relationship information or metadata mappings (e.g., similarity metrics, semantic correlations, etc.), descriptive information, values, etc. Moreover, the metadata store 224 can include metadata defined by one or more users, metadata generated by the data management system 200, metadata obtained from one or more sources such as the Internet, a metadata database, a data dictionary (e.g., dictionary of well-related data, attributes, tags, objects, names, resources, activities, operations, parameters, conditions, etc.), etc.

The data store 226 can store data captured, collected and/or generated by the data management system 200. For example, the data store 226 can store user inputs, well design or construction attributes, one or more graph data models, one or more data structures, one or more databases, one or more data presentations or views (e.g., a spreadsheet presentation, a three-dimensional data presentation view, a graphical user interface, a graph data model presentation or visualization, a well data rendering, a graph, a chart, etc.), one or more user preferences, user information (e.g., one or more user profiles, user history information, etc.), statistics, calculations generated by the data management system 200 (e.g., calculations from the metadata mapping engine 210, the analysis engine 212, the processing engine 214, etc.), output data, data analytics, measurements associated with a well (e.g., temperature, pressure, fluid properties, depth, etc.), processed events, messages, notifications, rules, actions, instructions, snapshots of data, data points, data changes, well data (e.g., wellbore configurations, formation configurations, wellbore conditions, wellbore depths, wellbore locations, mechanical properties of wellbore components, safety factors, etc.), and/or any other data.

As previously noted, the data management system 200 can include a metadata mapping engine 210, an analysis engine 212, a processing engine 214, and a rendering engine 216. The metadata mapping engine 210 can collect, store, monitor, generate, analyze, edit, and/or otherwise process metadata and/or mappings associated with events, well construction or design attributes, data fields or values, reports, objects, logical entities, etc. For example, the metadata mapping engine 210 can collect, generate, process, and/or store labels, tags, flags, relationships, identifiers, metrics (e.g., data or object similarity metrics and relationships, etc.) and/or any other metadata associated with well construction or design data (e.g., metadata associated with attributes, statistics, operations, conditions, events, users, well components, etc.), user data (e.g., user events, user preferences, user profiles, user statistics, etc.), modeling data (e.g., tables, databases, fields, graphs, objects, data models, structures, etc.), and so forth. The metadata mapping engine 210 can store such metadata and/or mappings in the metadata store 224, for example.

Such metadata and/or mappings can describe or identify various types of information used by the data management system 200, associate or correlate different information used by the data management system 200, index different information, compare different information, etc. The metadata and/or mappings can allow the data management system 200 to organize data, correlate data, query data, compare data, present data, store data, retrieve data, model data, etc. In some examples, the metadata and/or mappings can include descriptive metadata about data, objects, entities, users, resources, etc.; modeling metadata describing data structures or models and associated data; administrative metadata providing information about data, objects, and/or resources (e.g., timestamps, access information, modifications, data types, data generation, technical information, inputs, interactions, etc.); reference metadata describing the contents and/or quality of different information; statistical metadata; metrics (e.g., similarity metrics), etc.

The analysis engine 212 can collect, monitor, store, edit, generate, and/or otherwise process data analytics. For example, the analysis engine 212 can analyze information, such as events, metadata, attributes, operations data, statistics, rules or triggering actions, conditions, preferences, graph or model data, etc., and generate analytics and/or reports. In some cases, the analysis engine 212 can monitor a data feed in real time and provide analytics such as a number of surveys created per hour, a number of operations performed per day, etc. The analysis engine 212 can store data analytics in the data store 226, for example, for use by the data management system 200 as described herein.

The processing engine 214 can use data in the events store 222, the metadata store 224, the data store 226, and/or any other data sources, to generate data models and/or structures as described herein. For example, the processing engine 214 can use data in the events store 222, the metadata store 224, and the data store 226 to generate a graph data model for capturing, organizing, managing, querying, accessing, and viewing data associated with a well. In some implementations, the processing engine 214 can store any models, data structures, and/or data generated and/or collected by the processing engine 214 in the data store 226.

The rendering engine 216 can render data and/or views depicting various information, analytics, calculations, reports, statistics, events, attributes, etc., generated or obtained by the data management system 200. For example, the rendering engine 216 can render three-dimensional visualizations (e.g., graphical views, visual presentations, etc.) of data contained in a graph data model generated by the data management system 200 (e.g., via the processing engine 214), spreadsheet presentations of such data, graphs of such data, reports of such data, etc. The rendered data from the rendering engine 216 can be presented on a display device such as a computer screen, a television, a projector, a display device, etc. Moreover, the rendered data from the rendering engine 216 can have one or more formats and can include one or more types of information such as, for example and without limitation, text, images, video, audio, web page content, application content, a list, a table, a chart, a diagram, a log, a file, a graph, a three-dimensional structure, etc.

In some examples, the rendering engine 216 can generate and/or provide a graphical user interface (GUI) where a user can view data and/or outputs from the data management system 200; input data, preferences, and/or parameters to be stored or used by the data management system 200; modify data at the data management system 200; request data, such as reports, analytics, or visualizations, from the data management system 200; etc. For example, the rendering engine 216 can generate and/or provide a GUI where a user can define metadata, user preferences, well operations, well attributes, processing parameters, etc., used by the data management system 200. As another example, the rendering engine 216 can generate and/or provide a GUI where a user can request and/or access data reports, statistics, presentations (e.g., data views or visualizations, etc.), models, etc.

In some examples, a GUI generated and/or provided by the rendering engine 216 can display output data and/or calculation results from the data management system 200, such as data (e.g., statistics, activity, well construction attributes, operations, etc.) in a data structure (e.g., a graph-based model or data structure, a database, etc.) generated by the data management system 200. For example, the GUI can display information generated or obtained from the metadata mapping engine 210, the analysis engine 212, and/or the processing engine 214. As previously noted, the GUI can display such data and results in any graphical configuration and/or format such as a spreadsheet, a chart, a report, a log, a table, a list, a graph, a diagram, a file, an image, a video, audio, text, and/or any other form.

While the data management system 200 is shown in FIG. 2 to include certain components, one of ordinary skill in the art will appreciate that the data management system 200 can include more or fewer components than those shown in FIG. 2. For example, in some instances, the data management system 200 can also include one or more memory components (e.g., one or more RAMs, ROMs, caches, buffers, and/or the like), one or more input components, one or more output components, one or more processing devices that are not shown in FIG. 2, one or more hardware components that are not shown in FIG. 2, etc.

FIG. 3 illustrates example system flow 300 for generating a graph data model for well design and construction data. The well design and construction data can include, for example and without limitation, operations data, user activity, well attributes, reports, data values, statistics, timestamps, metadata, object information, resource information, conditions information, descriptive information, parameters, rules, preferences, user information, historical information, etc. While the example shown in FIG. 3 is described with respect to a graph data model, it should be noted that other examples can implement other data structures capable of capturing multiple levels or dimensions of data and data relationships. For example, in other implementations, the data model can be a structure containing objects representing data along multiple dimensions.

In system flow 300, the data management system 200 can use metadata from the mapping metadata 306 and data from the database 302 to generate a snapshot 304 of a graph data model. In some cases, the snapshot 304 can be generated using the processing engine 214 and/or the metadata mapping engine 210. Moreover, in some cases, the snapshot 304 can provide an initial graph data model containing specific well data (e.g., well attributes, events, user activity, operations data, conditions, statistics, historical data, metadata, data interactions, etc.) and data mappings or correlations based on the data from the database 302 and the metadata from the mapping metadata 306.

The database 302 can contain a range of well data such as, for example and without limitation, well construction or design attributes (e.g., location, depth, well configuration, properties and/or configuration of specific well components, types of fluids, types of formations, well conditions, etc.), operation details (e.g., types of operations performed, operation parameters or attributes, operation statistics, operation conditions, date or timestamps of operations, who (which users) performed the operations, operation results, etc.), engineering workflows, analytics, etc. The database 302 can include any other data previously described with respect to data store 226. In some cases, the database 302 can be hosted by, stored in, or part of data store 226. It should be noted that, in other examples, the data in database 302 can be stored in a different type of data model or structure than a database. The database 302 is used herein as a non-limiting example of a data structure for explanation purposes.

The mapping metadata 306 can include instructions indicating what data points (or types of data points) and data mappings or relationships should be captured or included in the snapshot 304. Thus, the data management system 200 can use the mapping metadata 306 to determine what data from the database 302 should be loaded or included in the snapshot 304 and how the data (and/or what data) should be mapped or correlated in the initial graph data model (e.g., the snapshot 304). In some cases, the mapping metadata 306 can include similarity metrics describing a relationship and/or degree of similarity between different data. Moreover, in some cases, the mapping metadata 306 can be stored in the metadata store 224 and/or some or all of the mapping metadata 306 can be generated or obtained using the metadata mapping engine 210.

In other cases, some or all of the mapping metadata 306 can be obtained from one or more other sources. For example, in some implementations, some or all of the mapping metadata 306 can be obtained from a metadata source 308A and/or a data dictionary 308N. The metadata source 308A can be a data store, database, utility or tool that maintains well-related metadata and/or synchronizes or collects well-related metadata from a number of metadata sources (e.g., databases, servers, repositories, applications, etc.). The data dictionary 308N can be a dictionary of attributes or labels pertaining to well-related objects, processes, activities, operations, parameters, conditions, resources, data, etc.

The data management system 200 can receive or obtain events 322 generated by (or involving) a user 320, such as an engineer, supervisor, etc., and use the events 322 as well as the mapping metadata 306 and the snapshot 304 to generate and/or modify a graph data model 330. In some cases, the events 322 can include a stream of data, messages, or notifications identifying specific events or activity. For example, the events 322 can include a stream of events or event messages identifying or describing user activity. To illustrate, the events 322 can include activity notifications describing or indicating user operations, user inputs, user configurations, data entered and/or modified by one or more users, system changes made by one or more users, user preferences provided by one or more users, user actions, which tools or entities were acted on by a user, etc. The events 322 can also include metadata and/or any other type of activity information.

In some cases, the data management system 200 can store or maintain some or all of the events 322 in the events store 222. Moreover, the data management system 200 can monitor the events store 222 and/or event messages for event information (e.g., events 322). In some examples, the data management system 200 can monitor and obtain event or activity information (e.g., events 322), and use the mapping metadata 306 to determine how to process the event or activity information. The mapping metadata 306 can include instructions specifying what data points from the events 322 to collect or filter, how or whether to filter the events 322, how to compose data records or outputs based on the events 322, how to persist data records or outputs to graph data model 330, etc.

Accordingly, in some cases, the data management system 200 can use instructions and information in the mapping metadata 306 to determine how or whether to filter 310 any of the event or activity information (e.g., events 322). For example, the data management system 200 can monitor events 322 and determine which events or event notifications to filter based on instructions in the mapping metadata 306 specifying what events and/or event information to filter.

In some examples, the data management system 200 can monitor and analyze 312 the events 322 to generate descriptive analytics based on the events 322. For example, the data management system 200 can analyze 312 the events 322 and generate, based on the events 322, analytics describing the number of surveys created per hour during one or more periods of time (e.g., a day, a week, a month, the construction of the well, etc.). In some cases, the data management system 200 can monitor the events 322 in real time (or near real time) and/or generate analytics as event data is obtained (e.g., in real time or near real time).

The data management system 200 can also use the events 322 and mapping metadata 306 to compose 314 data records or outputs for storage or inclusion in the graph data model 330. For example, the data management system 200 can monitor the events 322 and use the mapping metadata 306 to determine what events or event information to include in one or more data records or outputs composed for the graph data model 330, how to compose the one or more data records or outputs, etc. Moreover, after composing the one or more data records or outputs from the information in the events 322, the data management system 200 can persist 316 (e.g., insert, store, save, etc.) the one or more data records or outputs to the graph data model 330 for storage.

The graph data model 330 can be a data structure or model for storing, organizing, querying, retrieving, visualizing, analyzing, combining, and correlating well-related data such as attributes, operation data, conditions, events (e.g., user events, well events, etc.), values, statistics, configurations, preferences, rules, etc. The data in the graph data model 330 can include current and old or previous values, attributes, and/or well-related data. For example, the graph data model 330 can include a timeline of any particular value, attribute and/or event from the moment the value, attribute and/or event was created through any subsequent changes or interactions.

To illustrate, the graph data model 330 can include a timeline of a well design attribute, such as well depth, including the current attribute value (e.g., current well depth) and any prior attribute values (e.g., prior well depths) that have been modified or replaced by the current attribute value. In some cases, the timeline can include not only the current and prior values, but also additional information such as which user(s) modified the prior value and/or generated the current value, which application or tool was used to modify the prior value or generate the current value, etc. The timeline can allow a user to not only view or analyze the current value of specific well-related data, but also view or analyze any number of previous values of that specific well-related data. Such levels of information can provide a user with a more complete picture of the state and statistics of a well, including current state information and statistics as well as previous or historical state information and statistics.

In some cases, the graph data model 330 can include data describing a number of levels of interactions with any particular attribute in the graph data model 330. For example, the graph data model 330 can maintain data describing what user(s) created a particular attribute or report associated with a well; when the attribute or report was created, viewed, deleted, and/or modified; which user(s) viewed, deleted, and/or modified the attribute or report; how many times the attribute or report was viewed/opened or modified; and/or any other activity or interactions with the attribute or report.

The graph data model 330 can also provide organization, correlations and/or logical groupings of data, objects and/or entities (e.g., data structures or models, reports, tables, fields, records, data views, etc.) in the graph data model 330. Such organization, correlations and/or logical groupings can enable faster and more efficient data storage; more intelligent, cogent, intuitive and relevant visualizations and/or clusterings of data in the graph data model 330; more flexible, robust, and diverse queries of data in the graph data model 330; as well as storage space and time savings.

In some examples, the graph data model 330 can store well design and activity attributes and/or records, any changes to the well design and activity attributes and/or records, data identifying (e.g., name, description, etc.) the user(s) that made such changes, data identifying what tools or applications (e.g., well design applications, etc.) were used to make such changes, when such changes were made (e.g., a timestamp of each change), data identifying the type of user interactions with the attributes and/or records (e.g., add attribute or record, modify attribute or record, delete attribute or record, open attribute or record, close attribute or record, etc.), and so forth.

The graph data model 330 can also store a current value of the well design and activity attributes and/or records as well as any previous values of such well design and activity attributes and/or records, including values that have been modified and/or marked for deletion. For example, such data can be captured and persisted without removal even after new data, values, or changes are received or generated.

In some cases, the graph data model 330 can be used to generate an analysis 332 of the data in the graph data model 330, the well, conditions associated with the well, well design information, well and user activity or events, etc. For example, the graph data model 330 can be used to generate an analysis 332 of well-related data and/or triggering actions, such as triggering operations or conditions. In some non-limiting examples, the analysis 332 can include a report, a summary, a document, a message, and/or any other type of analysis output containing analytics generated from the attributes and/or data in the graph data model 330.

Moreover, given the structure and configuration of the graph data model 330 as described herein, the graph data model 330 can store, process, organize, retrieve, visualize, etc., significantly more data than other data structures and databases. For example, in some cases, the graph data model 330 can include a large amount of data integrated from a number of data structures, such as application databases, tables, records, etc. Accordingly, to better understand such large amounts of data, the data management system 200 can organize, cluster, correlate, group, and/or visualize some or all of the data in the graph data model 330. In some examples, the mapping metadata 306 can provide similarity metrics for attributes and/or data in the graph data model 330. The similarity metrics can be used to organize, cluster, correlate, group and/or visualize attributes and data from the graph data model 330.

For example, the similarity metrics can be used to group, cluster, organize and/or correlate relevant or similar attributes and data obtained or integrated from various data structures, such as various application databases, tables, records, models, etc. Attributes or data determined to be similar or relevant based on the similarity metrics can be grouped, clustered, organized, and/or correlated to help a user understand the vast amount of data integrated into the graph data model 330; allow the user to use more complex, granular, efficient and/or effective queries for searching data or attributes in the graph data model 330; save space used to store the vast amount of attributes and data in the graph data model 330; save time in accessing, storing, and/or analyzing the attributes and data in the graph data model 330; provide the user access to a larger amount of relevant or similar historical and/or current data in the graph data model 330; etc.

The graph data model 330 can also be used to generate a visualization 334 (e.g., a spreadsheet, a chart, a graph, a three-dimensional view or shape, etc.) of some or all of the data in the graph data model 330. In some implementations, the visualization 334 (e.g., a three-dimensional visualization) can show, for example, what percentage of attributes have data for a given well, what process was used to create the well design, and/or any other well design activity and characteristics. Moreover, in some examples, the mapping metadata 306 and/or similarity metrics in the mapping metadata 306 can be used to generate the visualization 334 and ensure that attributes and data in the visualization 334 are depicted, grouped, clustered, organized, positioned, and/or correlated in a logical, understandable, or intuitive manner. For example, the similarity metrics can be used to determine where (e.g., which coordinates within a view or three-dimensional space) and/or how to depict, cluster, organize, etc., similar or related attributes and/or data.

In some implementations, the visualization 334 can include one or more three-dimensional spaces. For example, the visualization 334 can include a three-dimensional space containing attribute cells or cubes. Each attribute cell or cube can represent a three-dimensional space containing one or more attributes and/or associated data. In some cases, attributes or data determined to be similar or relevant (e.g., based on the similarity metrics) can be depicted or located at neighboring or proximal coordinates within the three-dimensional space of an attribute cell or cube, to better convey and visually depict the relationship or similarity of such attributes or data. Moreover, attributes or data determined to be similar or relevant can be depicted with certain properties or characteristics (e.g., format, color, shape, size, position, opacity, etc.). Such organization, visual depiction, grouping, positioning, clustering, and/or correlation of attributes or data can help a user better understand the vast amount of data integrated into the graph data model 330 from one or more data structures and/or sources.

In some example three-dimensional visualizations (e.g., 334), each attribute can be represented as a cell or cube that captures a timeline or history of the attribute (e.g., previous and current values). The cells or cubes can be used to build a bigger structure (e.g., a bigger three-dimensional structure such as a cube) that represents all the attributes and data available in the graph data model 330 for a given well. Moreover, in some cases, each attribute cell or cube in a visualization, such as a three-dimensional visualization, can have visual characteristics or animations based on one or more factors. Non-limiting examples of such factors can include when the attribute was created or modified, who created the attribute, the type of attribute, data and/or activity associated with the attribute, a chronology of attribute values or data, a timeline of data input events, etc. For example, in some cases, each attribute cell or cube can light up or change visual characteristics (e.g., color, size, shape, angle, texture, opacity, etc.) based on a chronological ordering of timestamps indicating when the attribute and/or any other attributes were entered or created.

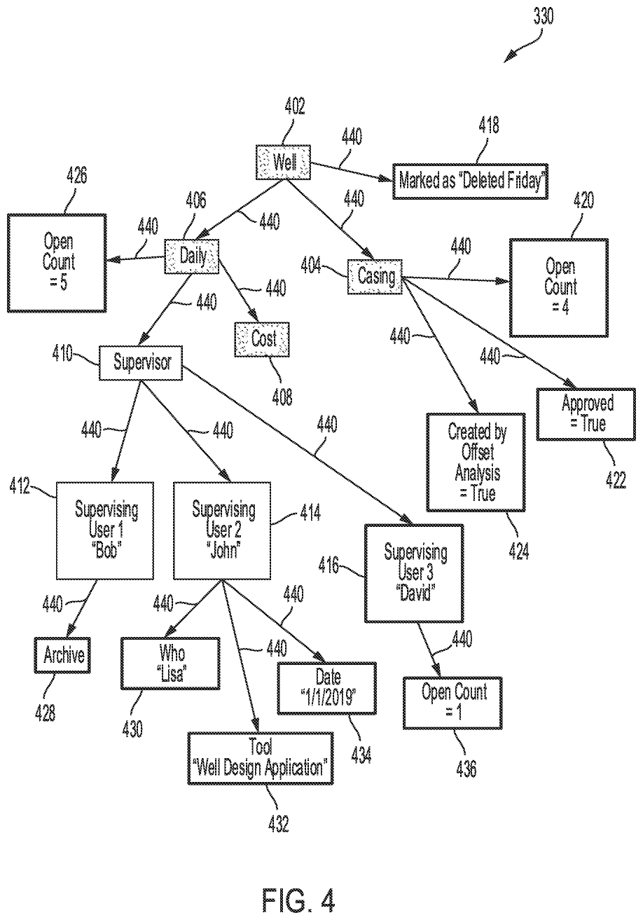

FIG. 4 illustrates an example graph data model 330 populated based on a series of well construction or design events (e.g., 322). The graph data model 330 can include nodes 402-436 and edges 440 (e.g., graphs, relationships, connections). Each node (402-436) can represent an entity, object or instance, such as a user, a place, a thing, a category, an event, an attribute, or any other piece of data. Moreover, the nodes 402-436 can store or include information or properties (e.g., values, identifiers, names, labels, tags, descriptors, etc.) associated with the nodes 402-436, respectively. In some illustrative examples, the information or properties in the nodes 402-436 can be represented by values or key-value pairs.

The edges 440 are lines connecting nodes to other nodes, and represent the relationship and/or dependencies between them (how such nodes are associated or related). The edges 440 or relationships can allow the stored data for the nodes to be linked together directly and enable robust or efficient queries for retrieving the stored data associated with one or more nodes. For example, in many cases, the edges 440 can allow data for some or all related nodes to be retrieved or accessed with one query or operation.

Moreover, the edges 440 can include properties, which can be represented by, for example and without limitation, values, key-value pairs, etc. In some examples, the properties associated with the edges 440 can describe or include the types of relationships between specific nodes (402-436) interconnected by respective edges, the specific values or data stored for the relationships between nodes, an indication of the start node of a relationship (e.g., an edge 440) between nodes, an indication of the end node of the relationship (e.g., edge 440) between nodes, and/or any other type of data.

In some examples, the data management system 200 can populate the graph data model 330 based on well construction or design events (e.g., events 322). For example, the data management system 200 can receive well construction or design events, and use such events as well as mapping metadata (e.g., 306) to populate the graph data model 330. To illustrate, in FIG. 4, when a user adds a well in a well planning application, the data management system 200 can populate the graph data model 330 with a well node 402 representing the well added in the well planning application and any associated well data. The well node 402 can be the root node (e.g., the parent or top level node) in the graph data model 330.

When a user adds a casing design associated with the well to a well design application, the data management system 200 can populate the graph data model 330 with a casing node 404 corresponding to the casing design (and associated data) added by the user. The casing node 404 can be connected to the well node 402 (e.g., as a child node) and can include any casing properties or data from the casing design. In some cases, the data management system 200 can determine or detect a number of times the casing node 404 was opened (e.g., viewed or accessed) by one or more users, and add an open count node 420 to the graph data model 330 with an edge 440 (e.g., relationship) connecting the open count node 420 to the casing record 404. The open count node 420 can include a property value indicating a number of open counts. For example, the open count node 420 can indicate the number of times the casing node 404 was opened as well as any other related data, such as an indication of which user opened the casing node 404 in each open count, a timestamp for each open count identifying a date/time when the casing node 404 was opened, etc.

In some cases, the data management system 200 can add child nodes to the casing node 404 to capture additional data and/or activities pertaining to the casing node 404. For example, if the casing design was created by an offset analysis, the data management system 200 can add a node 424 connected to the casing node 404 to indicate that the casing design was created by an offset analysis. The node 424 can include a property value indicating that the casing design was created by an offset analysis. In some cases, the node 424 can include or represent any other data pertaining to the offset analysis used to create the casing design.

Moreover, if the casing design is approved in the well design application, the data management system 200 can add an approval node 422 connected to the casing node 404 to indicate that the casing design was approved. The approval node 422 can include a property value indicating that the casing design was approved. In some cases, the approval node 422 can include properties or information about the casing design approval, such as who approved the casing design, when (e.g., time/date) was the casing design approved, why was the casing design approved, details about the approval process or decision, comments or information added by a user about the approval of the casing design, etc.

Furthermore, when a user adds a daily report in an application for tracking and reporting operations associated with the well, the data management system 200 can populate the graph data model 330 with a daily operations node 406 corresponding to the daily report added. The daily operations node 406 can be connected to the well node 402 (e.g., as a child node) and can represent data in the daily report, such as data about daily operations and activities associated with the well. For example, the daily operations node 406 can include an indication of the daily operations associated with the well, a description of the daily operations, an indication of which tools were used in the daily operations, an indication of which users were involved in the daily operations, a timestamp for each of the daily operations, etc.

When a user adds cost information or estimates to the daily record associated with the daily operations node 406, the data management system 200 can populate the graph data model 330 with a cost node 408 representing the cost information or estimates. The cost node 408 can be connected to the daily operations node 406 as a child node to correlate the cost node 408 with the daily operations node 406. In some cases, the cost information or estimates can include an actual or projected cost for each operation associated with the daily operations node 406. In other cases, the cost information or estimates can include an actual or projected cost for all daily operations associated with the daily operations node 406 and/or for the entire well design or construction project. In yet other cases, the cost node 408 can include properties associated with the cost information or estimates represented by the cost node 408, such as how the cost information or estimates were calculated, which user provided or generated the cost information or estimates, when was the cost information or estimates calculated, etc.

In some cases, the daily operations in the daily operations node 406 can have one or more supervisors. Accordingly, the data management system 200 can add a supervisor node 410 to the graph data model 200, representing the daily supervisors (e.g., the supervisors on the day of the operations reported in the daily operations node 406) associated with the daily operations. The supervisor node 410 can be connected to the daily operations node 406 as a child node in order to capture the relationship between the supervisor node 410 and the daily operations node 406.

In some cases, the well site may have multiple supervisors on a given day, such as a mud logger supervisor and a well site officer. To capture the different supervisors of the day, the data management system 200 can add supervising user nodes 412, 414, 416 to the graph data model 330, corresponding to the different supervisors. For example, in some cases, each supervisor may generate a summary of the operations and work performed on that day under the supervision of that supervisor. When the supervisors report operations and work performed that day under their supervision, the data management system 200 can add supervising user nodes 412, 414, 416 to the graph data model 330 respectively representing each of the supervisors that reported the operations and work performed that day. In some cases, the supervising user nodes 412, 414, 416 can associate the various supervisors with their respective reports.

The supervising user nodes 412, 414, 416 can be connected to the supervisor node 410 as child nodes in order to capture their relationship to the supervisor node 410 and the daily operations node 406. Moreover, each of the supervising user nodes 412, 414, 416 can have a property identifying the associated supervisor. In some cases, the supervising user nodes 412, 414, 416 can also include any other supervisor information, such as information indicating when the supervisors where active or on duty, information indicating a supervisor type (e.g., mud logger, well site officer, etc.), etc. For example, as previously noted, in some cases each supervisor may provide a daily summary, which can be included in the daily reports associated with the daily operations node 406. Thus, in some cases, the supervising user nodes 412, 414, 416 can include properties identifying or mapping the daily summaries to the respective supervisors that created such summaries.

The supervising user nodes 412, 414, 416 can also be connected to child nodes 428-436 representing specific attributes or activity related to supervising user nodes 412, 414, 416. For example, if supervising user node 412 is archived, the data management system 200 can add a child node 428 connected to the supervising user node 412 to indicate that the supervising user node 412 has been archived. The node 428 can include a property indicating that the supervising user node 412 has been archived. In some cases, the node 428 can include any other information pertaining to the archiving of the supervising user node 412, such as a date/time when the supervising user node 412 was archived, who archived the supervising user node 412, etc.

In another example, a user node 430, an application node 432, and a date node 434 can be added to the graph data model 330 and connected to the supervising user node 414 as child nodes to associate the supervising user node 414 with user, application, and date information related to the supervisor represented by the supervising user node 414. In this example, the user node 430 can represent and identify a user, such as a well operator, supervised by the supervisor represented by the supervising user node 414. The application node 432 can represent and identify an application used by the supervisor associated with the supervising user node 414, such as a well design application or tool. The date node 434 can represent and identify the date when the supervisor associated with the supervising user node 414 was active and/or on duty.

If a user opens (e.g., to view or modify) a particular record or object represented by a node in the graph data model 330, the data management system 200 can add and correlate an open count to the node associated with the opened record or object. For example, if a user opens the record or data represented by the supervising user node 416, the data management system 200 can add an open count node 436 to the graph data model 330, and connect the open count node 436 to the supervising user node 416 as a child node. The open count node 426 can include a property indicating an open count relating to the supervising user node 416.

As another example, if the daily operations node 406 (and/or its associated data) is opened (e.g., to view or modify) by one or more users, an open count node 426 can be added to the graph data model 330 and connected to the daily operations node 406 as a child node. The open count node 426 can include a property specifying an open count associated with the daily operations node 406. In some cases, the open count node 426 can include other properties or information associated with the activity (e.g., the open events) represented by the open count node 426. For example, the open count node 426 can include information identifying which user(s) opened the daily operations node 406 (and/or its associated data), when each open event occurred, etc.

As other data and/or events pertaining to the well (and/or its associated data/attributes) represented by the well node 402 are generated or received, the data management system 200 can use such events to populate the graph data model 330 with associated information. For example, if the well node 402 is marked as deleted by a user, the data management system 200 can populate the graph data model 330 with a delete node 418 connected to the well node 402. The delete node 418 can include a property indicating that the well node 402 was marked as deleted. In some cases, the delete node 418 can include other properties such as, for example and without limitation, a date when the well node 402 was marked as deleted, which user marked the well node 402 as deleted, etc.

As illustrated above, the graph data model 330 can be used to store and represent graph data, such as well-related data and activity. The graph data model 330 can be backed by a storage (e.g., 220, 226) that stores the graph data (e.g., the nodes, relationships or edges, properties, labels, tags, etc.) associated with the graph data model 330. Moreover, the graph data model 330 can ensure that data is stored efficiently. For example, in some cases, the graph data model 330 can ensure that data is stored efficiently by writing nodes and relationship close to each other.

In some implementations, the graph data model 330 can increase the speed of write operations by ensuring that each node is stored directly to its adjacent node(s) and relationship(s). In addition, such adjacency and/or structure of the graph data model 330 and its associated graph data can, in some cases, provide significantly fast query processing and data retrieval. The graph data model 330 can enable very fast graph traversals and data access/retrieval at least partly by leveraging the relationships, labels, properties, etc., associated with nodes in the graph data model 330. In some cases, the graph data model 330 can allow a large amount of data, such as a timeline of all well activity and information associated with a user, to be accessed/retrieved using a single query or a small number of queries.

For example, when a query for certain data in the graph data model 330 is generated, the nodes and node relationships relevant to the query can be quickly traversed to obtain all the data matching the query (e.g., satisfying the search criteria associated with the query). This way, the queried data can be quickly identified, retrieved and provided to the user that issued the query.

It should be noted that the nodes (402-436), edges or relationship (440), properties, labels, etc., in the example graph data model 330 shown in FIG. 4 are merely non-limiting examples provided for explanation purposes. One of ordinary skill in the art will recognize that other implementations of the graph data model 330 can include a different number, type, and configuration of nodes, edges or relationships, properties, labels, and characteristics than those shown in FIG. 4. For example, in some implementations, the graph data model 330 can include more or less nodes, one or more different node properties, one or more different node labels, one or more different elements such as tags, etc., and/or can include nodes representing or capturing different types of events, data, categories, objects, instances, entities, etc.

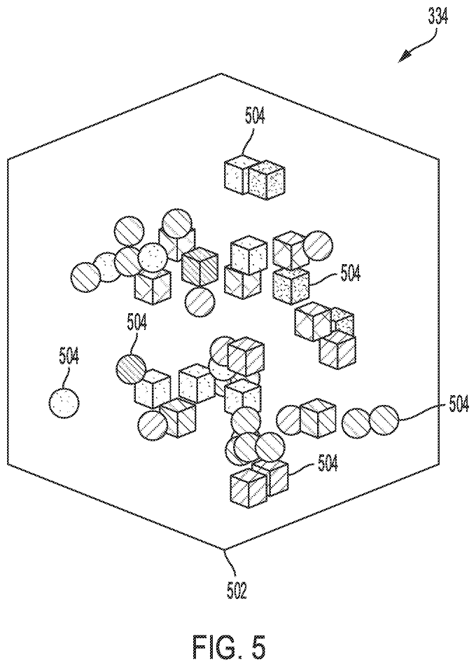

FIG. 5 illustrates an example visualization 334 of well construction data and activity in a graph data model (e.g., 330). In this example, the visualization 334 includes a three-dimensional space 502 representing the root (e.g., parent or top level) node of the graph data model used to generate the visualization 334. The root node of the graph data model can represent all the data and objects in the graph data model and/or the entire graph data model. However, in other examples, the three-dimensional space 502 can represent less than the entire graph data model (e.g., a portion of the graph data model), such as a subset of child nodes in the graph data model. In some examples, a user can specify what portions of the graph data model should be depicted or represented by the three-dimensional space 502.

The three-dimensional space 502 in this example is a three-dimensional cube. However, in other implementations, the three-dimensional space 502 can have a different shape, size, dimensionality, and/or any other characteristics. Moreover, the three-dimensional space 502 contains smaller three-dimensional objects 504. Each of the three-dimensional objects 504 can represent one or more nodes (and associated data) in the graph data model. For example, a three-dimensional object 504 can represent a user node (e.g., supervising user node 412, 414, or 416), an operations report node (e.g., daily operations node 406), a well component design node (e.g., casing node 404), a cost node (e.g., 408), etc.

In some implementations, all the three-dimensional objects 504 can represent a same type of node, such as user nodes. In other implementations, the three-dimensional objects 504 can represent different types of nodes, such as user, operation reports, and well component design nodes. Moreover, three-dimensional objects 504 can be depicted with different visual attributes used to visually convey certain information or attributes about the three-dimensional objects 504, such as they types of nodes (and/or the type of data associated with the nodes), the similarity of the nodes (and/or the type of data associated with the nodes), date or timeline information, a type of action or event associated with the nodes), a user or type of user associated with the nodes, etc.

For example, in some cases, the shape (e.g., square, sphere, triangle, etc.) of a three-dimensional object 504 can be used to depict a type of node or data (e.g., a user node, an action or event node, a well attribute node, a well operation node, etc.) represented by that three-dimensional object 504, a color of the three-dimensional object 504 can be used to depict a specific object or thing (e.g., a specific user, a specific well component, a specific application or tool, etc.), a location and/or proximity of a three-dimensional object 504 to one or more other three-dimensional objects 504 can be used to depict a similarity or relationship between such three-dimensional objects 504, a size of the three-dimensional object 504 can be used to depict whether the three-dimensional object 504 captures current data and/or historical data, etc.

In some cases, the visual attributes implemented to depict or represent different information about the three-dimensional objects 504 can be user-defined. For example, a user may specify that a certain shape should represent a user node containing data associated with a user, a different shape should represent a different type of node such as a well operation node, different colors should represent different node properties (e.g., a user identity, a date/time, a type of event or operation, etc.), and the relative location of three-dimensional objects 504 can represent a relative similarity (or degree of similarity) or a relationship between such three-dimensional objects 504. To illustrate, the user may specify that nodes or data associated with user “John” should be represented by a square, nodes or data associated with user “Lisa” should be represented by a sphere, nodes or data associated with a certain activity should be represented by the color blue, nodes or data associated with a different activity should be represented by the color red, different shades can be used to represent different number of changes made to the data associated with that node, etc.

This way, the user can quickly recognize or ascertain information about the various three-dimensional objects 504 from their visual appearance. For example, a user viewing the visualization 334 can look at a square object with a blue color and certain shade and quickly determine that the object represents the user “John”, a certain activity performed by John, and a certain amount of changes to the data associated with that node. Similarly, the user can look at an object shaped as a sphere and having a red color and specific shade and quickly determine that the object represents the user “Lisa”, a specific activity performed by Lisa, and a certain amount of changes applied to the associated data.

In some examples, the three-dimensional objects 504 can be located or positioned within the three-dimensional space 502 based on respective coordinates (e.g., x, y z) assigned to the three-dimensional objects 504. The coordinates can be assigned to the three-dimensional objects 504 based on one or more factors, such as a degree of similarity or a relationship between the various three-dimensional objects 504 (and/or their associated data). In some implementations, the similarity or relationship between three-dimensional objects 504 can be calculated based on a similarity metric provided by, for example, the mapping metadata, and can be based on the similarity or relationship between the data and/or attributes represented by the various three-dimensional objects 504, such as a corresponding user, a corresponding event or activity, a corresponding well component, a corresponding tool or application used, a corresponding date(s), a corresponding well attribute or property, etc.

In some cases, data points within a three-dimensional object 504 can also be configured, depicted, and/or organized based on one or more characteristics associated with the data points. For example, a data point within a three-dimensional object 504 may be located or positioned within the three-dimensional object 504 based on its relative similarity to other data points associated with the three-dimensional object 504. To illustrate, a three-dimensional object 504 having a square shape and a red color can represent a specific operations report associated with the user “John”.

Moreover, the three-dimensional object 504 can include a number of data points that are located or depicted at different coordinates within a three-dimensional coordinate system (e.g., x, y, z) represented by the three-dimensional objects 504. The relative coordinates of the different data points can be based on the relative similarities or relationships between the different data points so that the more similar or related data points are located or depicted closer together. Thus, in an example where data points coordinates are defined by the similarity or closeness in date of an event or activity represented by the data points, the data points that are closest in time (e.g., have the most similar dates) can have adjacent coordinates (e.g., 1, 1, 1 and 1, 1, 2) and as data points are farther in time they can have coordinates that are farther in distance within the coordinate system of the three-dimensional object 504. This way, similar or related data points can be clustered closer together within the three-dimensional object 504 and dissimilar or unrelated data points can be clustered farther apart within the three-dimensional object 504 so as to visually represent such similarities/dissimilarities or relationships.

In some implementations, three-dimensional objects 504 and/or data points within the three-dimensional objects 504 can be interactive and/or selectable. For example, in some cases, a user can select a three-dimensional object 504 and/or a data point within the three-dimensional object 504 to expand, zoom in, interact with, or drill down on the three-dimensional object 504 and/or the data point. To illustrate, a user can query or select a three-dimensional object 504 of interest to expand or zoom into that three-dimensional object 504 in order to view more details or a more detailed depiction of that three-dimensional object 504. The user can then select one or more data points within the three-dimensional object 504 to access more granular details about the one or more data points. In this way, the user can quickly navigate the visualization 334 and specific nodes or data of interest within the visualization 334 by expanding or selecting those nodes or data points having a specific characteristic(s) representing certain information or details of interest to the user.

In some examples, the graph data model 330 and/or the visualization 334 can be used to process queries and provide robust or comprehensive query results. For example, a user can query the graph data model 330 for all data or objects pertaining to a specific user. Given the relationship information captured in the graph data model 330 for different data and objects, the graph data model 330 can be quickly traversed based on the applicable relationships of data or objects in the graph data model 330 to identify the all data or objects pertaining to the specific user. The responsive results (e.g., the data or objects pertaining to the specific user) can be presented in the visualization 334 to allow the user to view, access, and interact with such data or objects through the visualization 334 in a user-friendly manner. The data or objects can be depicted in the visualization 334 using visual attributes as previously described, to facilitate the user's understanding and navigation of the information presented in the visualization 334.

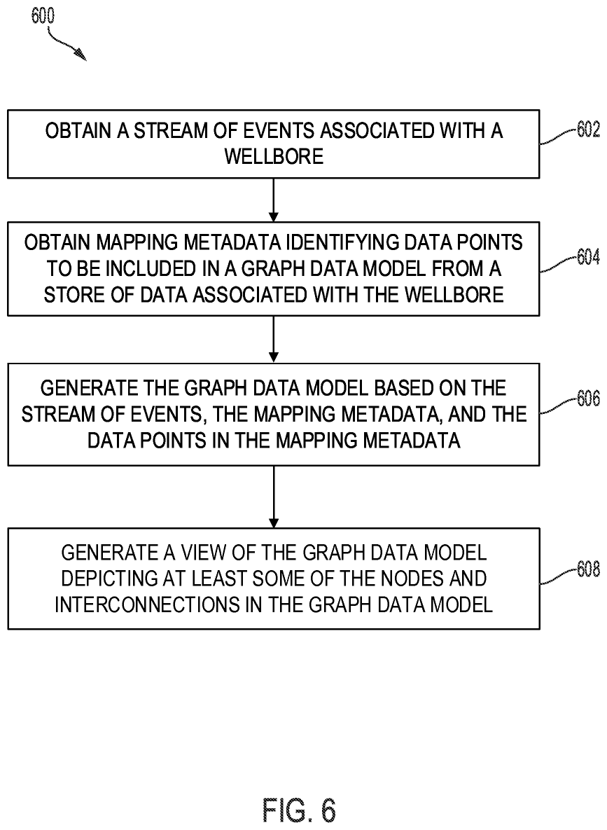

Having disclosed some example system components and concepts, the disclosure now turns to FIG. 6, which illustrates an example method 600 for generating a graph data model containing well construction activity and data. The steps outlined herein are exemplary and can be implemented in any combination thereof, including combinations that exclude, add, or modify certain steps.

At step 602, the data management system 200 can obtain a stream of events (322) associated with a wellbore (116). The stream of events can include messages, notifications, and/or data identifying specific events or activity. In some cases, the events or activity can include user activity, well operations, data operations (e.g., data inputs, data modifications, data outputs, etc.), conditions, and/or any other events or activity associated with the wellbore, a database of wellbore data, a wellbore tool, and so forth. For example, the stream of events can include events identifying or describing user interactions with wellbore data in a database, a tool or application, a storage, etc.

To illustrate, the events can include user modifications of data in a database, an application, storage, etc.; user inputs of well operations data, user data, well attributes, well design activity information, configurations data, user interactions information, user preferences, reports, notes, etc.; event metadata (e.g., timestamps, descriptive information, etc.); and so forth. In some cases, an event can include information about well design activity, such as information identifying well data (e.g., a well design attribute) added or modified in the data management system 200, an indication of which user(s) added or modified the well data, what tool or application was used to add or modify the well data, a date and/or time when the well data was added or modified, an indication of one or more user interactions (e.g., add, delete, edit, open or view, close, etc.) with the well data, previous versions of the well data (if any), etc.

At step 604, the data management system 200 can obtain mapping metadata (306) identifying data points (e.g., event data, well attributes, reports, user data, configurations, etc.) to be included in a graph data model (330) from a store of data (e.g., 226) associated with the wellbore. The data management system 200 can obtain the mapping metadata from one or more internal and/or external metadata sources. For example, the data management system 200 can obtain some or all of the mapping metadata from a metadata source (308A) containing mapping metadata, a data dictionary (308N) containing metadata and data definitions, a user, the Internet, a server, etc.

The data points identified in the mapping metadata can include, for example and without limitation, well statistics, well design attributes, well operations data, event data, data changes (e.g., well design attributes modified by one or more users), an indication of which user(s) made the data changes, an indication of which tools or applications were used to make the data changes, an indication of which user(s) were involved in one or more well operations, a timestamp identifying when the data changes and/or the one or more well operations were performed, user interactions with data and/or one or more applications, data describing a type of interaction between one or more users and one or more well design attributes, a timeline of one or more data points (e.g., a timeline of well design attributes, user operations, user inputs, etc.), and/or any other well-related data or events.

In some cases, the mapping metadata can also identify relationships between data points and/or items (e.g., objects, logical entities, etc.) defined or identified in the mapping metadata for inclusion in the graph data model. In some implementations, the relationships can be identified based on similarities or similarity metrics defined in the mapping metadata. For example, the mapping metadata can include similarity metrics describing similarities, dissimilarities, and/or relationships between different data points and/or items (e.g., objects, logical entities, etc.). The data points and/or items can correspond to specific nodes in the graph data model. The similarity metrics (and/or relationships) can be used to correlate and/or organize different data, nodes, logical entities, attributes, etc., included in the graph data model (e.g., via graph or node interconnections or edges). As further described below, in some cases, the similarity metrics (and/or relationships) can also be used to determine a relative location/proximity of nodes or objects depicted in a view generated based on the graph data model.

At step 606, the data management system 200 can generate the graph data model (330) based on the stream of events, the mapping metadata, and the data points identified in the mapping metadata. In some examples, the graph data model can include nodes (e.g., 402-436) representing logical entities (e.g., one or more users, wells, well components, well attributes, reports, objects, operations, databases, tables, tools or applications, user titles, conditions, etc.) associated with the data points. Moreover, the nodes can have interconnections (e.g., 440) based on data relationships defined in the mapping metadata. In some cases, each logical entity can correspond to one or more data points, such as data points pertaining to events, well attributes, reports, user interactions, well operations, configurations, etc.

To generate the graph data model, in some cases, the data management system 200 can initialize a version of the graph data model based on a snapshot (304) of data in a data store (e.g., 226) containing data for the wellbore, and populate the initialized graph data model with event data from the stream of events (322). In some examples, the snapshot can capture the data points identified by the mapping metadata, and the mapping metadata can be used to populate the graph data model with the event data. For example, the mapping metadata can be used to identify which event data to include in the graph data model, identify relationships between the event data used to populate the graph data model and any other data or data points in the graph data model.

In some cases, prior to populating the graph data model with the event data, the data management system 200 can filter one or more events from the stream of events based on one or more filtering parameters. The data management system 200 can then populate the graph data model with event data associated with the unfiltered events. Moreover, in some cases, the filtering parameters used to filter one or more events can be based on, or defined by, the mapping metadata. For example, the mapping metadata can include instructions specifying which types of events and/or event data to include or exclude from the graph data model. Any events and/or event data to be excluded from the graph data model according to the instructions from the mapping metadata can be filtered and excluded from the graph data model.

At step 608, the data management system 200 can generate a view (334) of the graph data model. The view can depict one or more of the nodes and interconnections in the graph data model. In some examples, the one or more nodes can store and/or represent data associated with the logical entities represented by the one or more nodes, such as well activity data, well attributes, user activity data, well operations, user reports, parameters, timestamps, historical well-related data (e.g., a timeline of well attributes, user interactions, etc.), statistics, data interactions, metadata, analytics, etc.

In some implementations, the view of the graph data model can include a three-dimensional structure (e.g., 502) having a three-dimensional space. The three-dimensional structure can contain three-dimensional objects (e.g., 504) in the three-dimensional space. Each three-dimensional object can visually represent or depict a node (or associated logical entity) in the graph data model. In some cases, each three-dimensional object can contain or correlate to data associated with the node or logical entity it represents or depicts. Moreover, a three-dimensional object can be selectable and/or interactive so as to allow a user to access additional data points or information from the three-dimensional object. For example, a user can select or click on a three-dimensional object to drill down and obtain more granular information associated with one or more data points contained or represented by the three-dimensional object. As another example, a user can hover a pointer over a three-dimensional object to view or obtain additional information related to that three-dimensional object such as a pop up window of additional information.

Moreover, in some implementations, each three-dimensional object can be depicted according to one or more visual attributes. Non-limiting examples of visual attributes can include geometric shapes (e.g., a cube, a cell, a square, a sphere, a triangle, a circle, a cylinder, etc.), colors (e.g., red, green, blue, etc.), locations, shading, graphical patterns (e.g., a line pattern, a shape pattern, a grid pattern, a dot pattern, etc.), sizes, brightness, line thickness, angles, etc. The one or more visual attributes can be used to visually identity the data, node, or logical entity and/or the type of data, node or logical entity represented by the three-dimensional object. For example, different shapes can be used to depict three-dimensional objects representing users and well attributes, different colors can be used to represent different operations and values associated with the three-dimensional objects, etc.

In some cases, the three-dimensional objects can be clustered within the three-dimensional structure according to relative proximities to each other within the three-dimensional space of the three-dimensional structure. The relative proximities can be based on the interconnections associated with the nodes in the graph data model and/or the data relationships defined in the mapping metadata. The data relationships defined in the mapping metadata can include similarity metrics describing similarities between different data points, objects, and/or logical entities associated with the nodes in the graph data model.

Moreover, the relative proximities between clustered three-dimensional objects can be determined based on the similarity metrics. For example, in some cases, the relative proximity between a group of three-dimensional objects can increase as a similarity defined for such three-dimensional objects by the similarity metrics increases. In other words, more similar (or more related) three-dimensional objects can be placed or clustered closer together than less similar (or less related) three-dimensional objects, and such similarities can be determined based on the similarity metrics in the mapping metadata. This way, a user can visually identity the more similar or related objects or data and the less similar or related objects or data based on the relative location/proximity of the three-dimensional objects. The depicted location and relative proximity of three-dimensional objects can be irrespective of the location/distance in a storage or database of the objects or data associated with the three-dimensional objects.

In some examples, each three-dimensional object can include and/or represent a set of data points corresponding to a logical entity associated with a node visually represented by the three-dimensional object, and each data point in the three-dimensional object can be depicted within a relative proximity to other data points in the three-dimensional object. Here, the relative proximity of different data points can be based on similarity metrics in the mapping metadata, as previously described. For example, different data points can be located or depicted at different coordinates within the three-dimensional object, and the distance or proximity between the coordinates of different data points can depend on the similarity metrics of the different data points. In some examples, data points having a higher similarity (e.g., as determined based on the similarity metrics) can be depicted within a closer distance or proximity than data points having a lower similarity. Thus, the more similar or related data points can be located or depicted closer together within a three-dimensional space of the three-dimensional object, and the less similar or related data points can be located or depicted farther away from each other.

To illustrate, three data points representing similar or related information about a user and having a high similarity can be located or depicted close to each other using, for example, coordinates [0, 0, 1], [0, 0, 2], and [0, 0, 3] in a three-dimensional coordinate system of a three-dimensional object. On the other hand, three other data points representing dissimilar or unrelated information about different objects and attributes can be located or depicted farther apart using, for example, coordinates [10, 1, 1], [5, 0, 10], and [10, 10, 10] in the three-dimensional coordinate system of the three-dimensional object. Thus, a user can see the first three data points located or depicted close to each other and determine that the three data points are similar or related based on their visual location and proximity. The user can also see the other three data points located or depicted farther apart and determine that those three data points are dissimilar or unrelated based on their visual location and proximity.

The data management system 200 can use the graph data model to process search queries and search requested data or objects. For example, the data management system 200 can receive a search query (e.g., from a user) requesting data about a logical entity (e.g., a user, a report, a well attribute, a well component, an event, etc.) represented by a node in the graph data model, and use the search query to search and identify the requested data about the logical entity in the graph data model. The data management system 200 can then provide the identified data in response to the search query.

In some cases, the data management system 200 can search and identify such data based on respective data points associated with the node representing the logical entity and/or based on one or more data points associated with one or more nodes having a direct or indirect connection to the node representing the logical entity. For example, the data management system 200 can receive a query for all data associated with a logical entity, and use the query to identify a node and any data associated with that logical entity. The data management system 200 can then traverse the graph data model to identify any other nodes, logical entities, and/or data related to the node and logical entity associated with the query. The data management system 200 can identify such other nodes, logical entities, and/or data based on a direct or indirect connection between the node representing the logical entity associated with the query and such other nodes in the graph data model.

To illustrate, the data management system 200 can identify one or more data points corresponding to the logical entity associated with the query. The logical entity can correspond to a node in the graph data model identified by the data management system 200 based on match (partial or full) between the node (and/or associated data) and the query. Based on a direct or indirect connection between the node associated with the logical entity and other nodes in the graph data model, the data management system 200 can then identify those other nodes (and associated logical entities) as well as any data associated with, or represented by, those other nodes.

In some examples, the data management system 200 can identify the direct or indirect connections between nodes by traversing the graph data model, as previously noted. For example, the data management system 200 can identify a node associated with the query, and follow each direct and indirect connection between that node and any other nodes in the graph to determine which nodes are directly or indirectly connected to that node. The connections between the various nodes can indicate that the data points associated with those nodes are relevant/related. Thus, the data management system 200 can retrieve such nodes (and/or associated data) and provide them in response to the query.

In some implementations, the data management system 200 can provide the data in response to the search query by presenting, in the view of the graph data model, the data, the node representing the logical entity associated with the search query, and/or one or more nodes in the graph data model having a direct or indirect connection to the node representing the logical entity. For example, the data management system 200 can present a three-dimensional view containing three-dimensional objects representing all the nodes and data identified based on the search query. A user can then access and/or view the three-dimensional objects and/or associated data right from the three-dimensional view generated in response to the search query.

In other implementations, the data management system 200 can provide the data in a different format or configuration. For example, the data management system 200 can provide the data in a report, a spreadsheet, a file, a list, a chart, a table, or any other data structure and/or configuration.

The data management system 200 can present the view (334) described herein on a display device at the data management system 200 and/or a remote device for storage and/or display.

Having disclosed example systems, methods, and technologies for generating a graph data model containing well construction activity and data, the disclosure now turns to FIG. 7, which illustrates an example computing device architecture 700 that can be employed to perform various steps, methods, and techniques disclosed herein. The various implementations will be apparent to those of ordinary skill in the art when practicing the present technology. Persons of ordinary skill in the art will also readily appreciate that other system implementations or examples are possible.

As noted above, FIG. 7 illustrates an example computing device architecture 700 of a computing device that can implement the various technologies and techniques described herein. For example, the computing device architecture 700 can implement the data management system 200 shown in FIG. 2 and perform various steps, methods, and techniques disclosed herein, such as one or more steps of the system flow 300 shown in FIG. 3 and/or the method 600 shown in FIG. 6.

The components of the computing device architecture 700 are shown in electrical communication with each other using a connection 705, such as a bus. The example computing device architecture 700 includes a processing unit (CPU or processor) 710 and a computing device connection 705 that couples various computing device components including the computing device memory 715, such as read only memory (ROM) 720 and random access memory (RAM) 725, to the processor 710.

The computing device architecture 700 can include a cache of high-speed memory connected directly with, in close proximity to, or integrated as part of the processor 710. The computing device architecture 700 can copy data from the memory 715 and/or the storage device 730 to the cache 712 for quick access by the processor 710. In this way, the cache can provide a performance boost that avoids processor 710 delays while waiting for data. These and other modules can control or be configured to control the processor 710 to perform various actions. Other computing device memory 715 may be available for use as well. The memory 715 can include multiple different types of memory with different performance characteristics. The processor 710 can include any general purpose processor and a hardware or software service, such as service 1 732, service 2 734, and service 3 736 stored in storage device 730, configured to control the processor 710 as well as a special-purpose processor where software instructions are incorporated into the processor design. The processor 710 may be a self-contained system, containing multiple cores or processors, a bus, memory controller, cache, etc. A multi-core processor may be symmetric or asymmetric.

To enable user interaction with the computing device architecture 700, an input device 745 can represent any number of input mechanisms, such as a microphone for speech, a touch-sensitive screen for gesture or graphical input, keyboard, mouse, motion input, speech and so forth. An output device 735 can also be one or more of a number of output mechanisms known to those of skill in the art, such as a display, projector, television, speaker device, etc. In some instances, multimodal computing devices can enable a user to provide multiple types of input to communicate with the computing device architecture 700. The communications interface 740 can generally govern and manage the user input and computing device output. There is no restriction on operating on any particular hardware arrangement and therefore the basic features here may easily be substituted for improved hardware or firmware arrangements as they are developed.

Storage device 730 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 725, read only memory (ROM) 720, and hybrids thereof. The storage device 730 can include services 732, 734, 736 for controlling the processor 710. Other hardware or software modules are contemplated. The storage device 730 can be connected to the computing device connection 705. In one aspect, a hardware module that performs a particular function can include the software component stored in a computer-readable medium in connection with the necessary hardware components, such as the processor 710, connection 705, output device 735, and so forth, to carry out the function.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the disclosed concepts may be otherwise variously embodied and employed, and that the appended claims are intended to be construed to include such variations, except as limited by the prior art. Various features and aspects of the above-described subject matter may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the method, algorithms, and/or operations described above. The computer-readable data storage medium may form part of a computer program product, which may include packaging materials.

The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

In the above description, terms such as “upper,” “upward,” “lower,” “downward,” “above,” “below,” “downhole,” “uphole,” “longitudinal,” “lateral,” and the like, as used herein, shall mean in relation to the bottom or furthest extent of the surrounding wellbore even though the wellbore or portions of it may be deviated or horizontal. Correspondingly, the transverse, axial, lateral, longitudinal, radial, etc., orientations shall mean orientations relative to the orientation of the wellbore or tool. Additionally, the illustrate embodiments are illustrated such that the orientation is such that the right-hand side is downhole compared to the left-hand side.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicate that at least a portion of a region is partially contained within a boundary formed by the object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder.

The term “radially” means substantially in a direction along a radius of the object, or having a directional component in a direction along a radius of the object, even if the object is not exactly circular or cylindrical. The term “axially” means substantially along a direction of the axis of the object. If not specified, the term axially is such that it refers to the longer axis of the object.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. The described features and steps are disclosed as possible components of systems and methods within the scope of the appended claims.

Moreover, claim language reciting “at least one of” a set indicates that one member of the set or multiple members of the set satisfy the claim. For example, claim language reciting “at least one of A and B” means A, B, or A and B.

Statements of the disclosure include:

Statement 1: A method comprising obtaining events associated with a wellbore; obtaining mapping metadata identifying data points to be included in a graph data model from a store of data associated with the wellbore; generating the graph data model based on the events, the mapping metadata, and the data points identified in the mapping metadata, the graph data model comprising nodes representing logical entities associated with the data points, the nodes having interconnections based on data relationships defined in the mapping metadata, wherein each logical entity corresponds to a set of data points from the data points; and generating a view of the graph data model, the view depicting at least some of the nodes and interconnections in the graph data model.

Statement 2: A method according to Statement 1, wherein at least some of the events comprise user activity, and wherein generating the graph data model comprises: initializing the graph data model based on a snapshot of at least a portion of the store of data, the snapshot capturing the data points identified by the mapping metadata; and populating the graph data model with event data from at least a portion of the events.

Statement 3: A method according to any of Statements 1 and 2, further comprising: filtering one or more of the events based on one or more filtering parameters, wherein the filtering parameters are based on the mapping metadata, and wherein the at least the portion of the events comprises unfiltered events from the events; and populating the graph data model with the event data from the unfiltered events.

Statement 4: A method according to any of Statements 1 through 3, wherein the view of the graph data model comprises a three-dimensional structure containing three-dimensional objects in a three-dimensional space, wherein each three-dimensional object visually represents a node, wherein each three-dimensional object is depicted according to one or more visual attributes comprising at least one of a geometric shape, a color, a shading, a graphical pattern, and a size.

Statement 5: A method according to any of Statements 1 through 4, wherein three-dimensional objects are clustered according to relative proximities to each other within the three-dimensional space, the relative proximities being based on at least one of the interconnections associated with the nodes in the graph data model and the data relationships defined in the mapping metadata.

Statement 6: A method according to any of Statements 1 through 5, wherein the data relationships defined in the mapping metadata comprise similarity metrics describing similarities between different data points associated with the nodes in the graph data model, and wherein the relative proximities are determined based on the similarity metrics, wherein a relative proximity between a set of three-dimensional objects increases as an associated similarity defined by the similarity metrics increases.

Statement 7: A method according to any of Statements 1 through 6, wherein each three-dimensional object comprises the set of data points corresponding to the logical entity associated with the node visually represented by the three-dimensional object, wherein each data point in the three-dimensional object is depicted within a relative proximity to other data points in the three-dimensional object, the relative proximity to other data points being based on the similarity metrics in the mapping metadata, wherein data points having a higher similarity are depicted within a closer proximity than data points having a lower similarity.

Statement 8: A method according to any of Statements 1 through 7, further comprising: receiving a search query requesting data about a logical entity represented by a node in the graph data model; identifying the data about the logical entity based on respective data points associated with the node representing the logical entity and one or more data points associated with one or more nodes having a direct or indirect connection to the node representing the logical entity, wherein the one or more data points associated with the one or more nodes are identified based on the direct or indirect connection between the one or more nodes and the node representing the logical entity; and providing the data in response to the search query.

Statement 9: A method according to any of Statements 1 through 8, wherein providing the data in response to the search query comprises presenting in the view of the graph data model at least one of the data, the node representing the logical entity, and the one or more nodes having a direct or indirect connection to the node representing the logical entity.

Statement 10: A method according to any of Statements 1 through 9, wherein the data points identified in the mapping metadata comprise at least one of well statistics, one or more well design attributes, one or more well operations, one or more changes made to the one or more well design attributes, one or more users that made the one or more changes to the one or more well design attributes, one or more tools or applications used by the one or more users to make the one or more changes, one or more users involved in the one or more well operations, a timestamp associated with at least one of the one or more changes and the one or more well operations, a type of interaction between one or more users and the one or more well design attributes, and a timeline of the one or more well design attributes.

Statement 11: A system comprising: one or more processors; and at least one computer-readable storage medium having stored therein instructions which, when executed by the one or more processors, cause the system to: obtain events associated with a wellbore; obtain mapping metadata identifying data points to be included in a graph data model from a store of data associated with the wellbore; generate the graph data model based on the events, the mapping metadata, and the data points identified in the mapping metadata, the graph data model comprising nodes representing logical entities associated with the data points, the nodes having interconnections based on data relationships defined in the mapping metadata, wherein each logical entity corresponds to a set of data points from the data points; and generate a view of the graph data model, the view depicting at least some of the nodes and interconnections in the graph data model.

Statement 12: A system according to Statement 11, wherein at least some of the events comprise user activity, and wherein generating the graph data model comprises: initializing the graph data model based on a snapshot of at least a portion of the store of data, the snapshot capturing the data points identified by the mapping metadata; and populating the graph data model with event data from at least a portion of the events.

Statement 13: A system according to any of Statements 11 and 12, the at least one computer-readable storage medium storing additional instructions which, when executed by the one or more processors, cause the system to filter one or more of the events based on one or more filtering parameters, wherein the filtering parameters are based on the mapping metadata, and wherein the at least the portion of the events comprises unfiltered events from the events; and populate the graph data model with the event data from the unfiltered events.

Statement 14: A system according to any of Statements 11 through 13, wherein the view of the graph data model comprises a three-dimensional structure containing three-dimensional objects in a three-dimensional space, wherein each three-dimensional object visually represents a node, wherein each three-dimensional object is depicted according to one or more visual attributes comprising at least one of a geometric shape, a color, a shading, a graphical pattern, and a size.

Statement 15: A system according to any of Statements 11 through 14, wherein three-dimensional objects are clustered according to relative proximities to each other within the three-dimensional space, the relative proximities being based on at least one of the interconnections associated with the nodes in the graph data model and the data relationships defined in the mapping metadata.

Statement 16: A system according to any of Statements 11 through 15, wherein the data relationships defined in the mapping metadata comprise similarity metrics describing similarities between different data points associated with the nodes in the graph data model, and wherein the relative proximities are determined based on the similarity metrics, wherein a relative proximity between a set of three-dimensional objects increases as an associated similarity defined by the similarity metrics increases.

Statement 17: A system according to any of Statements 11 through 16, wherein each three-dimensional object comprises the set of data points corresponding to the logical entity associated with the node visually represented by the three-dimensional object, wherein each data point in the three-dimensional object is depicted within a relative proximity to other data points in the three-dimensional object, the relative proximity to other data points being based on the similarity metrics in the mapping metadata, wherein data points having a higher similarity are depicted within a closer proximity than data points having a lower similarity.

Statement 18: A system according to any of Statements 11 through 17, the at least one computer-readable storage medium storing additional instructions which, when executed by the one or more processors, cause the system to receive a search query requesting data about a logical entity represented by a node in the graph data model; identify the data about the logical entity based on respective data points associated with the node representing the logical entity and one or more data points associated with one or more nodes having a direct or indirect connection to the node representing the logical entity, wherein the one or more data points associated with the one or more nodes are identified based on the direct or indirect connection between the one or more nodes and the node representing the logical entity; and provide the data in response to the search query.

Statement 19: A system according to any of Statements 11 through 18, wherein providing the data in response to the search query comprises presenting in the view of the graph data model at least one of the data, the node representing the logical entity, and the one or more nodes having a direct or indirect connection to the node representing the logical entity.

Statement 20: A system according to any of Statements 11 through 19, wherein the data points identified in the mapping metadata comprise at least one of well statistics, one or more well design attributes, one or more well operations, one or more changes made to the one or more well design attributes, one or more users that made the one or more changes to the one or more well design attributes, one or more tools or applications used by the one or more users to make the one or more changes, one or more users involved in the one or more well operations, a timestamp associated with at least one of the one or more changes and the one or more well operations, a type of interaction between one or more users and the one or more well design attributes, and a timeline of the one or more well design attributes.

Statement 21: A non-transitory computer-readable storage medium comprising instructions stored on the non-transitory computer-readable storage medium, the instructions, when executed by one more processors, cause the one or more processors to obtain events associated with a wellbore; obtain mapping metadata identifying data points to be included in a graph data model from a store of data associated with the wellbore; generate the graph data model based on the events, the mapping metadata, and the data points identified in the mapping metadata, the graph data model comprising nodes representing logical entities associated with the data points, the nodes having interconnections based on data relationships defined in the mapping metadata, wherein each logical entity corresponds to a set of data points from the data points; and generate a view of the graph data model, the view depicting at least some of the nodes and interconnections in the graph data model.

Statement 22: A non-transitory computer-readable storage medium according to Statement 21, wherein at least some of the events comprise user activity, and wherein generating the graph data model comprises: initializing the graph data model based on a snapshot of at least a portion of the store of data, the snapshot capturing the data points identified by the mapping metadata; and populating the graph data model with event data from at least a portion of the events.

Statement 23: A non-transitory computer-readable storage medium according to any of Statements 21 and 22, storing additional instructions which, when executed by the one or more processors, cause the one or more processors to filter one or more of the events based on one or more filtering parameters, wherein the filtering parameters are based on the mapping metadata, and wherein the at least the portion of the events comprises unfiltered events from the events; and populate the graph data model with the event data from the unfiltered events.

Statement 24: A non-transitory computer-readable storage medium according to any of Statements 21 through 23, wherein the view of the graph data model comprises a three-dimensional structure containing three-dimensional objects in a three-dimensional space, wherein each three-dimensional object visually represents a node, wherein each three-dimensional object is depicted according to one or more visual attributes comprising at least one of a geometric shape, a color, a shading, a graphical pattern, and a size.

Statement 25: A non-transitory computer-readable storage medium according to any of Statements 21 through 24, wherein three-dimensional objects are clustered according to relative proximities to each other within the three-dimensional space, the relative proximities being based on at least one of the interconnections associated with the nodes in the graph data model and the data relationships defined in the mapping metadata.

Statement 26: A non-transitory computer-readable storage medium according to any of Statements 21 through 25, wherein the data relationships defined in the mapping metadata comprise similarity metrics describing similarities between different data points associated with the nodes in the graph data model, and wherein the relative proximities are determined based on the similarity metrics, wherein a relative proximity between a set of three-dimensional objects increases as an associated similarity defined by the similarity metrics increases.

Statement 27: A non-transitory computer-readable storage medium according to any of Statements 21 through 26, wherein each three-dimensional object comprises the set of data points corresponding to the logical entity associated with the node visually represented by the three-dimensional object, wherein each data point in the three-dimensional object is depicted within a relative proximity to other data points in the three-dimensional object, the relative proximity to other data points being based on the similarity metrics in the mapping metadata, wherein data points having a higher similarity are depicted within a closer proximity than data points having a lower similarity.

Statement 28: A non-transitory computer-readable storage medium according to any of Statements 21 through 27, storing additional instructions which, when executed by the one or more processors, cause the one or more processors to receive a search query requesting data about a logical entity represented by a node in the graph data model; identify the data about the logical entity based on respective data points associated with the node representing the logical entity and one or more data points associated with one or more nodes having a direct or indirect connection to the node representing the logical entity, wherein the one or more data points associated with the one or more nodes are identified based on the direct or indirect connection between the one or more nodes and the node representing the logical entity; and provide the data in response to the search query.

Statement 29: A non-transitory computer-readable storage medium according to any of Statements 21 through 28, wherein providing the data in response to the search query comprises presenting in the view of the graph data model at least one of the data, the node representing the logical entity, and the one or more nodes having a direct or indirect connection to the node representing the logical entity.

Statement 30: A non-transitory computer-readable storage medium according to any of Statements 21 through 29, wherein the data points identified in the mapping metadata comprise at least one of well statistics, one or more well design attributes, one or more well operations, one or more changes made to the one or more well design attributes, one or more users that made the one or more changes to the one or more well design attributes, one or more tools or applications used by the one or more users to make the one or more changes, one or more users involved in the one or more well operations, a timestamp associated with at least one of the one or more changes and the one or more well operations, a type of interaction between one or more users and the one or more well design attributes, and a timeline of the one or more well design attributes.

Statement 31: A system comprising means for performing a method according to any of Statements 1 through 10.

What is claimed is:

1. A method comprising:
obtaining events associated with a wellbore;
obtaining mapping metadata identifying data points to be included in a graph data model from a store of data associated with the wellbore;
generating the graph data model based on the events, the mapping metadata, and the data points identified in the mapping metadata, the graph data model comprising nodes representing logical entities associated with the data points, the nodes having interconnections based on data relationships defined in the mapping metadata, wherein each logical entity corresponds to a set of data points from the data points; and
generating a view of the graph data model, the view depicting at least some of the nodes and interconnections in the graph data model.

2. The method of claim 1, wherein at least some of the events comprise user activity, and wherein generating the graph data model comprises:
initializing the graph data model based on a snapshot of at least a portion of the store of data, the snapshot capturing the data points identified by the mapping metadata; and
populating the graph data model with event data from at least a portion of the events.

3. The method of claim 2, further comprising:
filtering one or more of the events based on one or more filtering parameters, wherein the filtering parameters are based on the mapping metadata, and wherein the at least the portion of the events comprises unfiltered events from the events; and
populating the graph data model with the event data from the unfiltered events.

4. The method of claim 1, wherein the view of the graph data model comprises a three-dimensional structure containing three-dimensional objects in a three-dimensional space, wherein each three-dimensional object visually represents a node, wherein each three-dimensional object is depicted according to one or more visual attributes comprising at least one of a geometric shape, a color, a shading, a graphical pattern, and a size.

5. The method of claim 4, wherein three-dimensional objects are clustered according to relative proximities to each other within the three-dimensional space, the relative proximities being based on at least one of the interconnections associated with the nodes in the graph data model and the data relationships defined in the mapping metadata.

6. The method of claim 4, wherein the data relationships defined in the mapping metadata comprise similarity metrics describing similarities between different data points associated with the nodes in the graph data model, and wherein the relative proximities are determined based on the similarity metrics, wherein a relative proximity between a set of three-dimensional objects increases as an associated similarity defined by the similarity metrics increases.

7. The method of claim 6, wherein each three-dimensional object comprises the set of data points corresponding to the logical entity associated with the node visually represented by the three-dimensional object, wherein each data point in the three-dimensional object is depicted within a relative proximity to other data points in the three-dimensional object, the relative proximity to other data points being based on the similarity metrics in the mapping metadata, wherein data points having a higher similarity are depicted within a closer proximity than data points having a lower similarity.

8. The method of claim 1, further comprising:
receiving a search query requesting data about a logical entity represented by a node in the graph data model;
identifying the data about the logical entity based on respective data points associated with the node representing the logical entity and one or more data points associated with one or more nodes having a direct or indirect connection to the node representing the logical entity, wherein the one or more data points associated with the one or more nodes are identified based on the direct or indirect connection between the one or more nodes and the node representing the logical entity; and
providing the data in response to the search query.

9. The method of claim 8, wherein providing the data in response to the search query comprises presenting in the view of the graph data model at least one of the data, the node representing the logical entity, and the one or more nodes having a direct or indirect connection to the node representing the logical entity.

10. The method of claim 1, wherein the data points identified in the mapping metadata comprise at least one of well statistics, one or more well design attributes, one or more well operations, one or more changes made to the one or more well design attributes, one or more users that made the one or more changes to the one or more well design attributes, one or more tools or applications used by the one or more users to make the one or more changes, one or more users involved in the one or more well operations, a timestamp associated with at least one of the one or more changes and the one or more well operations, a type of interaction between one or more users and the one or more well design attributes, and a timeline of the one or more well design attributes.

11. A system comprising:
one or more processors; and
at least one computer-readable storage medium having stored therein instructions which, when executed by the one or more processors, cause the system to:
obtain events associated with a wellbore;
obtain mapping metadata identifying data points to be included in a graph data model from a store of data associated with the wellbore;
generate the graph data model based on the events, the mapping metadata, and the data points identified in the mapping metadata, the graph data model comprising nodes representing logical entities associated with the data points, the nodes having interconnections based on data relationships defined in the mapping metadata, wherein each logical entity corresponds to a set of data points from the data points; and
generate a view of the graph data model, the view depicting at least some of the nodes and interconnections in the graph data model.

12. The system of claim 11, wherein at least some of the events comprise user activity, and wherein generating the graph data model comprises:
initialize the graph data model based on a snapshot of at least a portion of the store of data, the snapshot capturing the data points identified by the mapping metadata; and
populate the graph data model with event data from at least a portion of the events.

13. The system of claim 12, wherein the at least one computer-readable storage medium comprises instructions which, when executed by the one or more processors, cause the system to:
filter one or more of the events based on one or more filtering parameters, wherein the filtering parameters are based on the mapping metadata, and wherein the at least the portion of the events comprises unfiltered events from the events; and
populate the graph data model with the event data from the unfiltered events.

14. The system of claim 11, wherein the view of the graph data model comprises a three-dimensional structure containing three-dimensional objects in a three-dimensional space, wherein each three-dimensional object visually represents a node, wherein each three-dimensional object is depicted according to one or more visual attributes comprising at least one of a geometric shape, a color, a shading, a graphical pattern, and a size, and wherein the geometric shape comprises at least one of a sphere, a square, a rectangle, a triangle, a cell, a diamond, and a cube.

15. The system of claim 14, wherein three-dimensional objects are clustered within the three-dimensional space according to relative proximities to each other, the relative proximities being based on similarity metrics in the mapping metadata describing similarities between different data points associated with the nodes in the graph data model, wherein a relative proximity between a set of three-dimensional objects increases as an associated similarity defined by the similarity metrics increases.

16. The system of claim 15, wherein each three-dimensional object comprises the set of data points corresponding to the logical entity associated with the node visually represented by the three-dimensional object, wherein each data point in the three-dimensional object is depicted within a relative proximity to other data points in the three-dimensional object, the relative proximity to other data points being based on the similarity metrics in the mapping metadata, wherein data points having a higher similarity are depicted within a closer proximity than data points having a lower similarity.

17. The system of claim 11, wherein the at least one computer-readable storage medium comprises instructions which, when executed by the one or more processors, cause the system to:
receive a search query requesting data about a logical entity represented by a node in the graph data model;
identify the data about the logical entity based on respective data points associated with the node representing the logical entity and one or more data points associated with one or more nodes having a direct or indirect connection to the node representing the logical entity, wherein the one or more data points associated with the one or more nodes are identified based on the direct or indirect connection between the one or more nodes and the node representing the logical entity; and
in response to the search query, present, in the view of the graph data model, at least one of the data, the node representing the logical entity, and the one or more nodes having a direct or indirect connection to the node representing the logical entity.

18. The system of claim 11, wherein the data points in the mapping metadata comprise at least one of well statistics, one or more well design attributes, one or more well operations, one or more changes made to the one or more well design attributes, one or more users that made the one or more changes to the one or more well design attributes, one or more tools or applications used by the one or more users to make the one or more changes, one or more users involved in the one or more well operations, a timestamp associated with at least one of the one or more changes and the one or more well operations, a type of interaction between one or more users and the one or more well design attributes, and a timeline of the one or more well design attributes.

19. A non-transitory computer-readable storage medium comprising:
instructions stored on the non-transitory computer-readable storage medium, the instructions, when executed by one more processors, cause the one or more processors to:
obtain events associated with a wellbore;
obtain mapping metadata identifying data points to be included in a graph data model from a store of data associated with the wellbore;
generate the graph data model based on the events, the mapping metadata, and the data points identified in the mapping metadata, the graph data model comprising nodes representing logical entities associated with the data points, the nodes having interconnections based on data relationships defined in the mapping metadata, wherein each logical entity corresponds to a set of data points from the data points; and
generate a view of the graph data model, the view depicting at least some of the nodes and interconnections in the graph data model.

20. The non-transitory computer-readable storage medium of claim 19, wherein the view of the graph data model comprises a three-dimensional structure containing three-dimensional objects in a three-dimensional space, wherein each three-dimensional object visually represents a node, wherein each three-dimensional object is depicted according to one or more visual attributes, wherein the three-dimensional objects are clustered within the three-dimensional space according to relative proximities to each other, the relative proximities being based on similarity metrics describing similarities between respective data points associated with the nodes in the graph data model, wherein a relative proximity between a set of three-dimensional objects increases as an associated similarity defined by the similarity metrics increases.
